(19) United States
(12) Patent Application Publication
(10) Pub. No.: US 2013/0127336 A1
(43) Pub. Date: May 23, 2013

(54) INFLUENCE OF INDIUM IODIDE ON CERAMIC METAL HALIDE LAMP PERFORMANCE

(71) Applicants: Raghu Ramaiah, Mentor, OH (US); Zoltan Toth, Budapest (HU)

(72) Inventors: Raghu Ramaiah, Mentor, OH (US); Zoltan Toth, Budapest (HU)

(73) Assignee: General Electric Company

(21) Appl. No.: 13/298,598

(22) Filed: Nov. 17, 2011

(51) Int. Cl. H01J 61/20; H01J 9/26

(52) U.S. Cl. 313/640; 445/26

(57) ABSTRACT

The present disclosure relates to a discharge lamp with improved color point, Dccy and CRI. More specifically, the invention provides a ceramic metal halide (CMH) lamp exhibiting improved color point, Dccy and CRI with little or no loss in other lamp performance parameters. For example, the lamp in accord with at least one embodiment of the invention exhibits excellent lumen output, lamp CCT, and efficacy, in addition to improved color parameters. In one embodiment, the lamp demonstrating these characteristics is a CMH lamp having low levels of indium iodide included in the dose thereof.

### BACKGROUND OF THE DISCLOSURE

The present disclosure relates to a discharge lamp having improved color point, Dccy and CRI, without showing a negative effect on lumen output or lamp CCT. It finds particular application in connection with ceramic metal halide lamps having low levels of indium iodide included in the dose thereof, and will be described with particular reference thereto.

High Intensity Discharge (HID) lamps are high-efficiency lamps that can generate large amounts of light from a relatively small source. These lamps are widely used in many applications, including highway and road lighting, lighting of large venues such as sports stadiums, floodlighting of buildings, shops, industrial buildings, and projectors, to name but a few. The term “HID lamp” is used to denote different kinds of lamps. These include mercury vapor lamps, metal halide lamps, and sodium lamps. Metal halide lamps, in particular, are widely used in areas that require a high level of brightness at relatively low cost. HID lamps differ from other lamps because their functioning environment requires operation at high temperature and high pressure over a prolonged period of time. Also, due to their usage and cost, it is desirable that these HID lamps have comparatively long useful lives and produce a consistent level of brightness and color of light. Although in principle, HID lamps can operate with either an alternating current (AC) supply or a direct-current (DC) supply, in practice, the lamps are usually driven via an AC supply.

Discharge lamps produce light by ionizing a vapor fill material, such as a mixture of rare gases, metal halides and mercury with an electric arc passing between two electrodes. The electrodes and the fill material are sealed within a translucent or transparent discharge vessel that maintains the pressure of the energized fill material and allows the emitted light to pass through it. The fill material, also known as a “dose,” emits a desired spectral energy distribution in response to being excited by the electric arc. For example, halides provide spectral energy distributions that offer a broad choice of light properties, e.g. color temperatures, color renderings, and luminous efficacies.

With current technology, lamp chemistries provide very beneficial properties on most performance metrics, but often do not reach desired performance in the areas of color point and Dccy, for example. These parameters relate directly to the color of light emitted by the lamp, and therefore are directly related to the satisfaction of the consumer when using the lamp. Efforts aimed at solving problems regarding the color of emitted light generally involve changing the lamp dose, however even the slightest change therein has proven to result in losses, and sometimes substantial losses, with regard to other performance and photometric parameters. In other words, efforts to improve lamp color have done so at the expense of other important lamp parameters.

Unexpectedly, the present invention achieves improved color point, Dccy and CRI of the lamp, while causing only negligible losses in other performance and photometric parameters of the lamp. This is accomplished by including indium iodide in the lamp dose at levels so low that the original lamp dose need not be altered. The result is a lamp exhibiting excellent performance with regard to lumens, efficacy, and light color, based on increased emissions in the 440-470 nm wavelength range. By wider variation of the amount of indium added to the dose of the lamp, further improvement in the color properties (e.g. CRI) of the lamp can be achieved, though possibly at the expense of shift of the color temperature (CCT) or a slight decrease in the lumen output, which may in some cases be acceptable.

### SUMMARY OF THE DISCLOSURE

In an exemplary embodiment, a lamp includes a discharge vessel having sealed therein an ionizing fill including at least an inert gas, a low amount of indium iodide, and a further halide fill. The further halide fill may include a sodium halide, a thallium halide, at least one of a calcium halide and/or strontium halide, and at least one of a rare earth halide selected from the group consisting of lanthanum, cerium, praseodymium, samarium, and neodymium, and combinations thereof, though other rare earth halides may be included depending on the particular lamp and the chemistry of the fill.

In one embodiment of the invention, the foregoing combination includes lanthanum halide as the rare earth component.

According to the invention, the inclusion of a small amount of indium iodide in the lamp dose significantly affects the light output with regard to the color thereof. Because the amount of indium iodide necessary to achieve the benefits disclosed herein is small, the remaining dose components, which are generally used in other comparable lamps, need not be altered, or need be altered only slightly. Therefore, no special processing changes are required to manufacture a lamp in accord with an embodiment hereof. In addition, an added benefit is seen in the fact that the amount of mercury needed to support full and efficient lamp operation may be reduced. It is known that mercury can cause problems with regard to toxicity in use and in disposal. Therefore, any reduction in the amount used is a benefit. With the addition of indium iodide, even in low dose amounts, the amount of mercury needed for start-up and operation may be reduced by as much as 15%-20%.

In yet another embodiment of the invention, a method of forming a lamp is provided. The method includes providing a discharge vessel having sealed therein an ionizing fill, this fill including an inert gas, indium iodide, and a further halide component. The halide component includes a sodium halide, a thallium halide, at least one of a calcium halide and/or strontium halide, and at least one of a rare earth halide selected from the group consisting of lanthanum, cerium, praseodymium, samarium, and neodymium and combinations thereof, though other rare earth halides may be included depending on the particular lamp and the chemistry of the fill. The method further includes positioning electrodes within the discharge vessel to energize the fill in response to a voltage applied thereto. It may be appreciated the current invention is not limited to any particular manufacturing method or processing.

A primary benefit realized by the lamp according to the invention is enhanced color of emitted light due to dose composition including at least a very small amount of indium iodide in addition to other common dose components.

Other features and benefits of the lamp according to the invention will become more apparent from reading and understanding the following detailed description.

### BRIEF DESCRIPTION OF THE DRAWINGS

FIG. 1 is a cross-sectional view of an HID lamp according to the exemplary embodiment;

FIG. 2 is a graph showing the shift in color point from a dose not including InI to the dose composition including a small amount (0.5 wt %) of InI;

FIG. 3 is a graph showing the spectral emittance of a lamp having a dose including 3.1 wt % InI as compared to a lamp without InI included in the dose;

FIG. 4 is a plot of lumen output as a function of low (up to 0.5 wt %) InI content in a 20 W test tube;

FIG. 5 is a plot of lumen output as a function of higher (up to 5 wt %) InI content in a 70 W test tube;

FIG. 6 is a plot of CCT as a function of low (up to 0.5 wt %) InI content in a 20 W test tube;

FIG. 7 is a plot of CCT as a function of higher (up to 5 wt %) InI content in a 70 W test tube;

FIG. 8 is a plot of CRI as a function of low (up to 0.5 wt %) InI content in a 20 W test tube;

FIG. 9 is a plot of CRI as a function of higher (up to 5 wt %) InI content in a 70 W test tube;

FIG. 10 is a plot of dccy as a function of low (up to 0.5 wt %) InI content in a 20 W test tube;

FIG. 11 is a plot of dccy as a function of higher (up to 5 wt %) InI content in a 70 W test tube;

FIG. 12 provides a surface plot of change of the CRI combining the 20 W and 70 W from a reference point (a base cell in each test) as a function of the InI amount and power of the lamp;

FIG. 13 provides a surface plot of change of the dccy combining the 20 W and 70 W from a reference point (a base cell in each test) as a function of the InI amount and power of the lamp; and

FIG. 14 is a boxplot of the operating voltage of three groups of lamps with different amount if InI and altered Hg taking the effect of InI into account to provide the same level of voltage.

### DETAILED DESCRIPTION OF THE PREFERRED EMBODIMENTS

The present disclosure relates to a discharge lamp with improved color point, Dccy and CRI. More specifically, the invention provides a ceramic metal halide (CMH) lamp exhibiting improved color point, Dccy and CRI with little or no loss in other lamp performance parameters. For example, the lamp in accord with at least one embodiment of the invention exhibits excellent lumen output, lamp CCT, and efficacy, in addition to improved color parameters. In one embodiment, the lamp demonstrating these characteristics is a CMH lamp having low levels of indium iodide included in the dose thereof. As such, the following disclosure provides for a lamp having higher efficacies and better color performance than other comparable lamps currently available but that do not include indium iodide in the fill.

As described in various aspects, the lamp is able to simultaneously satisfy photometric targets without compromising targeted reliability or lumen maintenance. Some additional photometric properties that are desirable in a lamp design include CCT, and Dccy. Further, enhanced CRI and lamp efficacy are achieved.

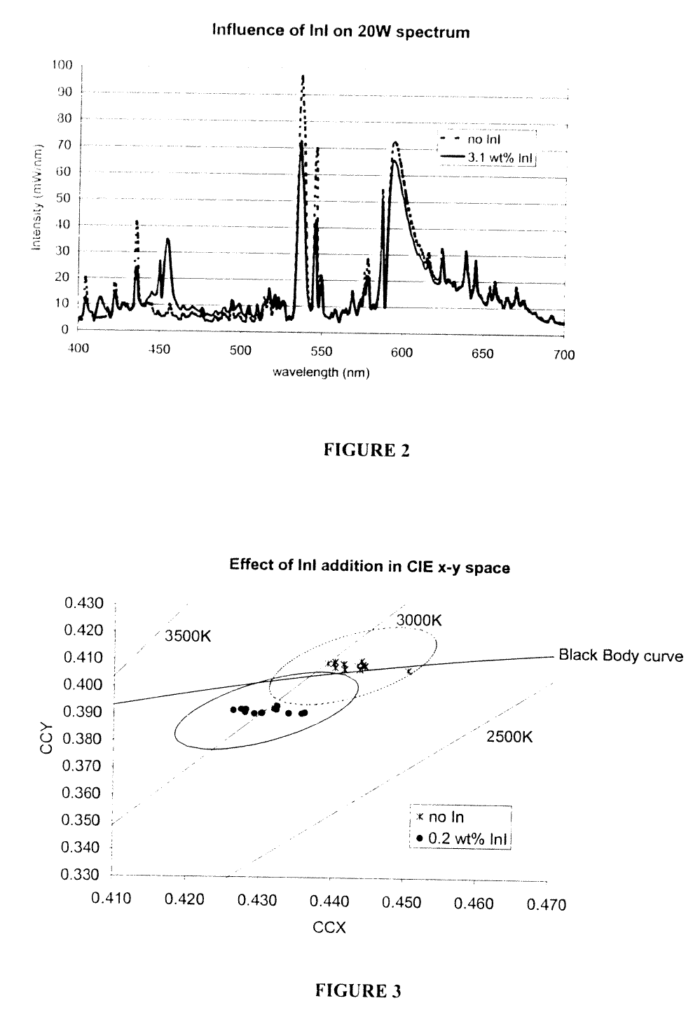

Correlated Color Temperature (CCT) is defined as the absolute temperature, expressed in degrees Kelvin (K), of a black body radiator when the chromaticity (color) of the black body radiator most closely matches that of the light source. CCT may be estimated from the position of the chromatic coordinates (u, v) in the Commission Internationale de l'Eclairage (CIE) 1960 color space. The lamp in accord with the invention as described herein may exhibit a more preferred white light. As such, an exemplary lamp in accord herewith may exhibit a correlated color temperature between for example, about 2700° K and about 4500° K, e.g., 3000° K. For example, a lamp including a fill containing calcium halide but no indium iodide, may operate at a correlated color temperature (CCT) of at least about 3,000° K. When indium iodide is added to this lamp dose at a low level, as shown in Table 1 below, the lamp continues to operate at a similar CCT, e.g., at about 3000° K, thus providing the same color temperature, as shown in FIG. 2. The color consistency is also proven in FIG. 2 by the presence of the color points within the same 6 step McAdam Ellipse. One advantage, then, to adding indium iodide at a very low level is seen in the fact that while other operating parameters, as will be discussed below, are enhanced, the CCT may be held substantially constant. The dose compositions of a control lamp and a lamp in accord with an embodiment of the invention, including a low amount of InI, are given in Table 1 in wt %.

TABLE 1

| Dose | w/o InI | w InI |
|---|---|---|
| (wt %) | (Lamp Control) | (Lamp InI) |
| LaI₃ | 16.3 | 16.3 |
| NaI | 52.0 | 52.0 |
| TlI | 6.7 | 6.7 |
| CaI₂ | 25 | 24.8 |
| InI | 0.0 | 0.2 |

As another example, a comparable lamp, including a fill containing strontium halide and again no indium iodide, may operate at a correlated color temperature (CCT) of at least about 4,000K. Similarly, if the lamp including strontium halide is altered only slightly to include a very low level of indium iodide, the lamp CCT will not change significantly. The foregoing are but a few possible embodiments of the invention, and are provided merely to demonstrate that the presence of indium iodide, even at very low dose levels, has no significant effect on color temperature of the lamp. It will be appreciated by one skilled in the relevant field of technology that the present invention is in no way limited to the specific embodiments described above, and various modifications, including fills and temperatures, are contemplated.

Dccy is the difference in chromaticity of the color point on the Y axis (CCY), from that of the standard black body curve. The exemplary embodiment may have a Dccy of greater than about −0.015 but less than about +0.005 with respect to the black body locus. In that instance where the lamp lies directly on the black body locus the Dccy=0.000. With reference again to Table 1 and FIG. 2, an experimental 20 W lamp dose including a fill of sodium halide, thallium halide, calcium halide and lanthanum halide may exhibit a Dccy of about 0.0021. The addition of even the very small dose of indium iodide to the lamp dose, as indicated in Table 1, however, results in a Dccy of −0.0107. By very carefully controlling the amount of indium iodide added, the Dccy may be controlled. The addition of indium iodide improves the Dccy of the lamp, moving the chromaticity point below the Black body curve, as shown in FIG. 2, where stars representing the InI-free control lamps are clustered above the black body indicator and circles representing lamps including InI fall below the black body indicator. It is further noted that the CCT, however, remains substantially constant, at about 3000K. It is expected that the same result will be achieved with most conventional lamp designs by the addition of only a small amount of indium iodide to the fill.

The color rendering index (CRI) is an indication of a lamp's ability to show individual colors relative to a standard, and is derived from a comparison of the lamp's spectral distribution compared to a standard (typically a black body) at the same color temperature. There are fourteen special color rendering indices (Ri, where i=1-14) which define the color rendering of a light source when used to illuminate standard color tiles. The general color rendering index (Ra) is the average of the first eight special color rendering indices (which correspond to non-saturated colors) expressed on a scale up to 100. Unless otherwise indicated, color rendering is expressed herein in terms of the Ra. An experimental 20 watt lamp may have a design requirement of 80/81. A conventional lamp dose comprising sodium halide, thallium halide, calcium halide and lanthanum halide, but without indium iodide may exhibit a CRI of 78. However, with the addition of indium iodide to the dose, the CRI of this same lamp improves to 81.

Higher efficiency of the exemplary embodiment is achieved due to dose composition and the amount of each dose component added to the arc tube. The design requirement of a relatively low Ra allows for the total dose weight to be held to a minimum, while allowing for dose composition to favor higher amounts of the more efficacious species, such as sodium halide, and lower amounts of the less efficacious species, such as lanthanum halide. As the halide dose weight is reduced, the vapor pressure within the arc tube also reduces, leading to an increase in efficiency. Indium iodide has a high vapor pressure of about 8 atm at 1200° K, and therefore there will be present in the discharge in a greater amount, i.e. a higher atomic % of In. As such, the indium will contribute more to the emission. In an exemplary dose system consisting of LaI₃-NaI-TlI-CaI₂ and 0.2 wt % of InI, the InI vapor pressure, estimated from Raoult's law, will be in the order of magnitude of 1×10⁻² atm, which is on the same order of magnitude as the majority of the aforementioned dose components. With the inclusion of indium iodide in the fill, even at a very low level, significant change results in the emission spectrum of the lamp. More specifically, light emission between 440 nm and 470 nm is increased as a direct result of the inclusion of indium in the dose. With reference to FIG. 3, there is shown an increase in that region where In contributes to the emission spectrum. A relatively high, i.e., 3.1 wt %, InI content is shown in FIG. 3 for easy observation of the changes in the spectra. This increase in spectral power correlates to a significant improvement in the color of light emitted. This, in combination with the CCT and Dccy performance parameters of a lamp having an InI-containing dose as discussed above, show the inclusion of indium as part of the lamp dose to have a very beneficial effect.

All of the foregoing ranges, CCT, Dccy, CRI, and emission spectra, may be simultaneously optimized and satisfied in the present lamp design including InI in the lamp dose. Unexpectedly, this can be achieved with only negligible impact on lamp reliability or lumen maintenance. Thus, for example, an exemplary lamp may exhibit a CRI and color point correlating to improved color quality, i.e., white light emission, and yet maintain lumen output and lamp life in accord with known, desirable standards, which have not been achievable using conventional dose compositions.

In one embodiment, a lamp assembly having physical parameters in accord with known lamp designs is provided. The lamp includes a discharge vessel housing electrodes and an ionizing fill sealed within the vessel. The ionizing fill includes an inert gas, indium iodide, and a further halide component including a sodium halide, a thallium halide, at least one of a calcium halide and/or strontium halide, and at least one rare earth halide, for example lanthanum, cerium, praseodymium, samarium, and neodymium, and combinations thereof, though other rare earth halides may be included depending on the particular lamp and the chemistry of the fill.

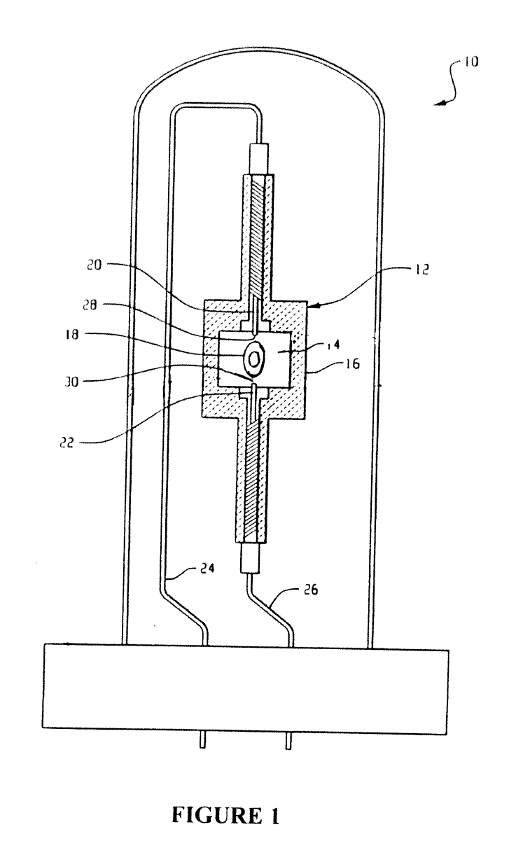

With reference to FIG. 1, a cross-sectional view of an exemplary HID lamp 10 is shown. The lamp includes a discharge vessel or arc tube 12, which defines an interior chamber 14. The discharge vessel wall 16 may be formed of a ceramic material, such as alumina, or other suitable light-transmissive material, such as quartz glass. An ionizable fill 18 is sealed in the interior chamber 14. Electrodes 20, 22, which may be formed from for example tungsten, though other electrode materials may also be used, are positioned at opposite ends of the discharge vessel so as to energize the fill when an electric current is applied thereto. The two electrodes 20 and 22 are typically fed with an alternating electric current via conductors 24, 26 (e.g., from a ballast, not shown). Tips 28, 30 of the electrodes 20, 22 are spaced by a distance which defines the arc gap. When the lamp 10 is powered, indicating a flow of current to the lamp, a voltage difference is created across the two electrodes. This voltage difference causes an arc across the gap between the tips 28, 30 of the electrodes. The arc results in a plasma discharge in the region between the electrode tips 28, 30. Visible light is generated and passes out of chamber 14, through wall 16.

In one embodiment, the lamp shows significant spectral enhancement in the region of about 440 nm to about 470 nm, in the visible light portion of the spectrum. For example FIG. 3, as noted above, provides a spectral output graph comparing the emittance of two otherwise identical lamps, except that one includes indium iodide in the fill and the other is devoid of indium iodide in the fill. A relatively high, i.e., 3.1 wt %, InI content is shown for easy observation of the changes in the spectra.

With further reference to FIG. 2, providing data regarding the lamp compositions shown in Table 1, FIG. 2 illustrates more clearly how the inclusion of InI in the lamp dose influences the color properties of a lamp. Color points are provided for two substantially identical lamp doses, as set forth in Table 1, the only difference being that one lamp dose included InI. In this graph the chromaticity coordinates of the two groups of the lamps, ccx vs. ccy are shown. The chromaticity coordinates of the InI containing lamps shifted toward a preferred color point below the block body. The lamp dose including InI in each case provided color points just below the black body locus, which equates to improved color properties, such as Dccy, i.e., more desirable white light.

To further test the premise, i.e., that InI need not be included in the lamp dose at a level such that other dose components would need to be reduced or operating parameters sacrificed, a typical lamp dose comprising Na:La:Ca:Tl, with no In (Ex. 1), was altered to include 2.4 wt % and 4.8 wt %, by weight of the total dose of InI (Ex.s 2-3, respectively). Further, the three levels of InI (0%, 2.4% and 4.8%) were tested against increasing amounts of NaI present in the dose. The weight percent of NaI was increased from 45 wt % (Ex.s 1-3), to 48.1 wt % (Ex.s 4-6), and then to 51.2 wt % (Ex.s 7-9) of the dose. Similarly, the wt % of InI was increased at each NaI level from 0% (Ex.s 1, 4, 7), to 2.4 wt % (Ex.s 2, 5, 8), and finally to 4.8 wt % (Ex.s 3, 6, 9). The tests were accomplished in otherwise identical 70 W lamps. Table 2 below sets forth the nine doses:

TABLE 2

| Example | NaI wt % | InI wt % |
|---|---|---|
| 1 | 45 | 0 |
| 2 | 44 | 2.4 |
| 3 | 45 | 2.8 |
| 4 | 48.1 | 4.8 |
| 5 | 48.1 | 2.4 |
| 6 | 48.1 | 4.8 |
| 7 | 51.2 | 0 |
| 8 | 51.2 | 2.4 |
| 9 | 51.2 | 2.4 |

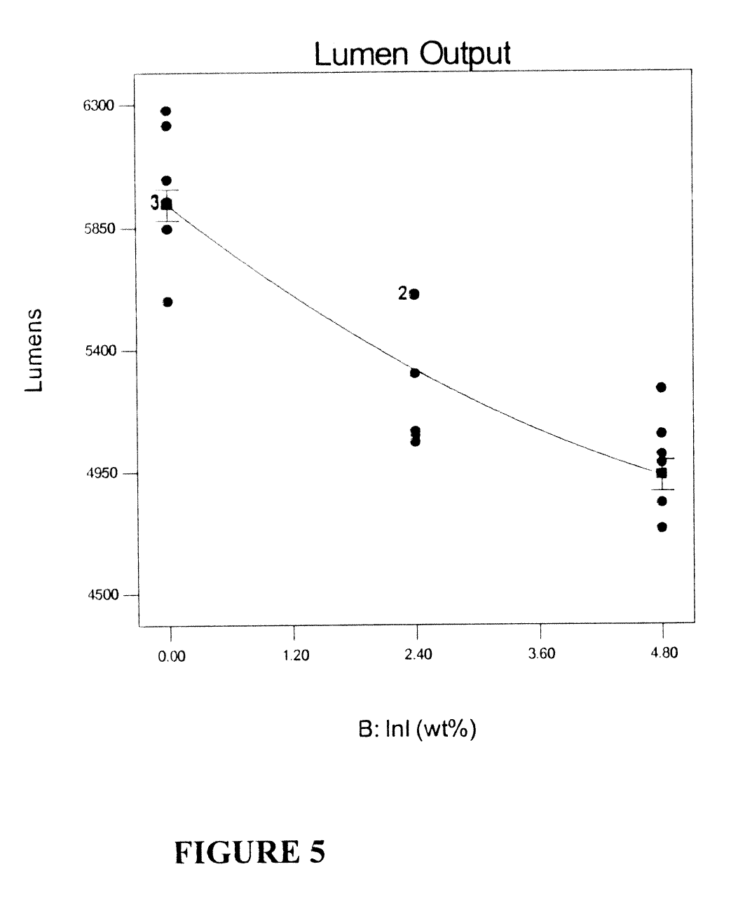

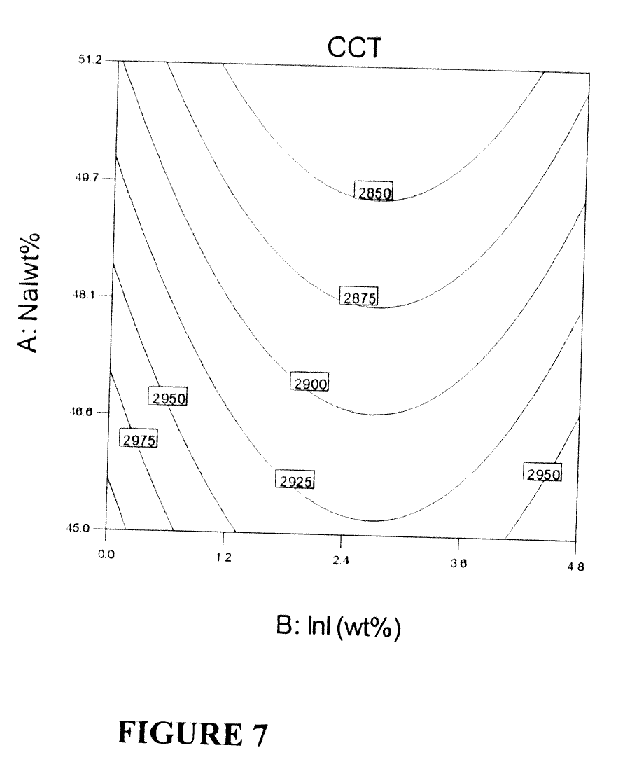

FIGS. 5, 7, 9 and 11 illustrate the data collected from these tests in plots as a function of the InI amount (FIG. 5) or contour plots as a function of the amounts of InI and NaI (FIGS. 7, 9, 11).

To further demonstrate the optimization shown above regarding the amount of indium iodide added to the lamp dose, tests were also done on 20 W lamps with low levels of InI added to the lamp dose. The same test method used to generate the data set forth in Table 2 was again used, this time to include different levels if InI (0%, 0.23 wt % and 0.47 wt %) and different levels of TlI (3.5 wt %, 6.7 wt % and 9.9 wt %). The dose combinations were again prepared in otherwise identical lamps, and were consistent with that shown in Table 3.

TABLE 3

| Example | TlI wt % | InI wt % |
|---|---|---|
| 10 | 3.5 | 0 |
| 11 | 9.9 | 0 |
| 12 | 3.5 | 0.47 |
| 13 | 9.9 | 0.47 |
| 14 | 6.7 | 0.23 |
| 15 | 6.7 | 0 |

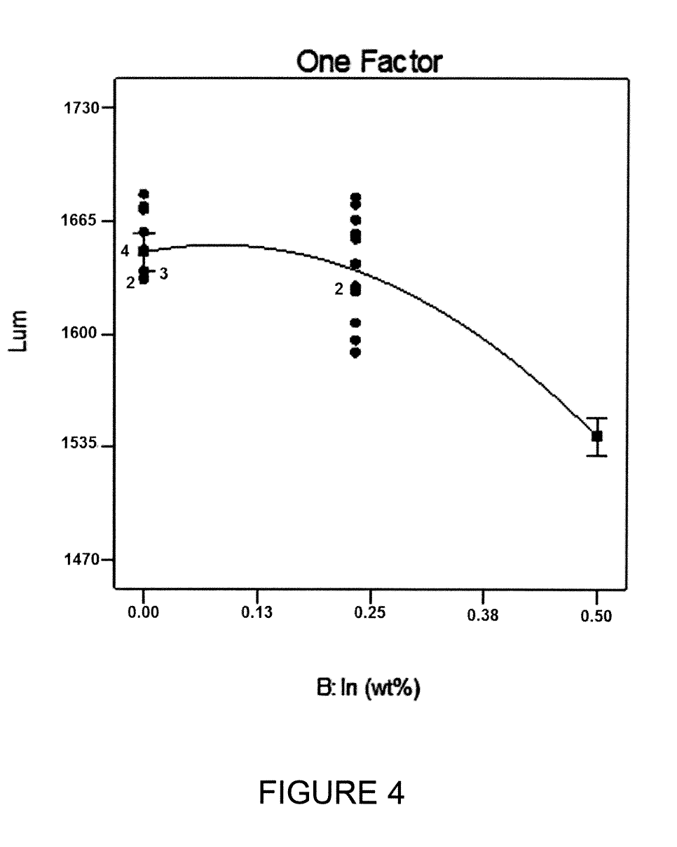

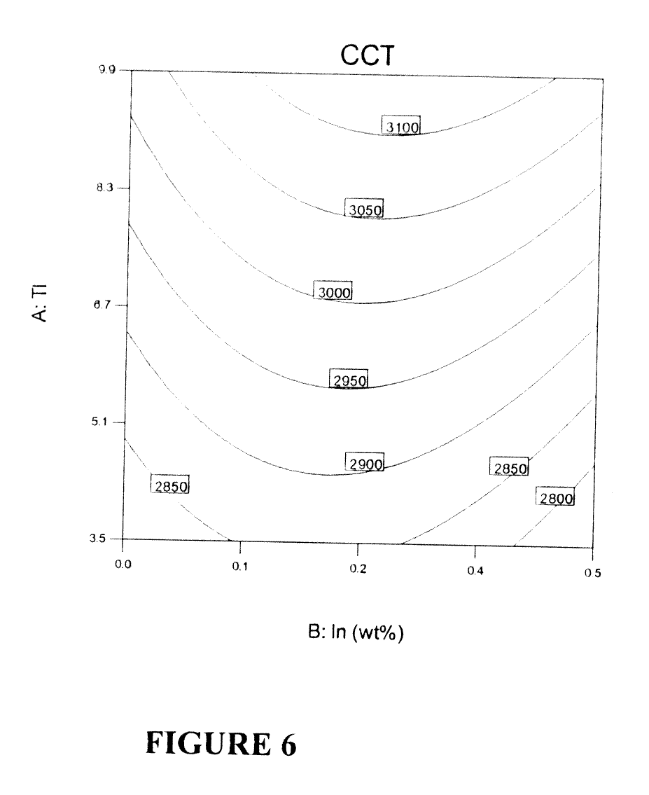

FIGS. 4, 6, 8 and 10 illustrate the data collected from these tests in plots as a function of the InI amount (FIG. 4) or contour plots as a function of the amounts of InI and TlI (FIGS. 6, 8, 10).

FIG. 5 plots Lumens, a measure of the total “amount” of visible light emitted by the lamp, as a function of InI weight percent in the case of the higher InI level test, i.e. 4.8 wt % InI. This graph illustrates that the lumen level of the lamp decreases if InI is added to the lamp, even at the level of only a few weight percent order of magnitude. The amount of InI added must, therefore, be set up carefully to benefit the aforementioned advantages of color and CRI with minimal loss of lumens, i.e. the light output. This is shown in FIG. 4, which shows the lumen output as a function of InI amount in the case of the low InI level test. One can see that the decrease of lumen output is negligible for a dose including InI in the range of 0-0.3 wt %. Above this level the lumen output starts to decrease. If, for instance, as an expense of color properties improvement 7% lumen drop is allowed, one can add 0.5 wt % of InI in the case of a 20 W lamp under our experimental conditions or approximately 2.2 wt % of InI in the case of a 70 W lamp.

FIGS. 6 and 7 provide a contour plot measuring the CCT of the aforementioned compositions in the case of low and high InI level test respectively. The surface plot of FIG. 6 indicates that as the amount of indium iodide is varied in the range of 0-0.5 wt %, there is only a slight change in the CCT. FIG. 7, the plot of the wider InI range shows, that if the amount of InI is increased from 0 to about 2.4 wt %, the CCT of the lamp decreased by approximately 100° K. The plot shows the CCT dependence on the NaI content as well. The dose composition of the lamp can be determined accordingly depending on the planned color properties of the lamp. It will be appreciated by those skilled in the art that since the required amount, or added amount, of the InI is low, compared to the total halide weight of the dose, the change of the molar or weight percent of the other dose elements will also be minimal. The observed change, therefore, can be attributed almost completely to the effect of the In emission, rather than to the change of the composition of the other dose elements, for example NaI, as shown in the example below.

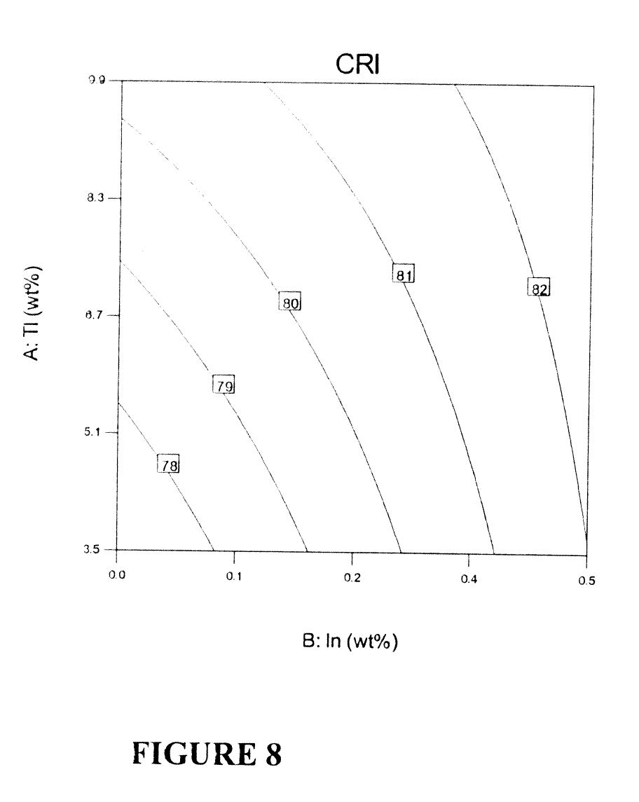

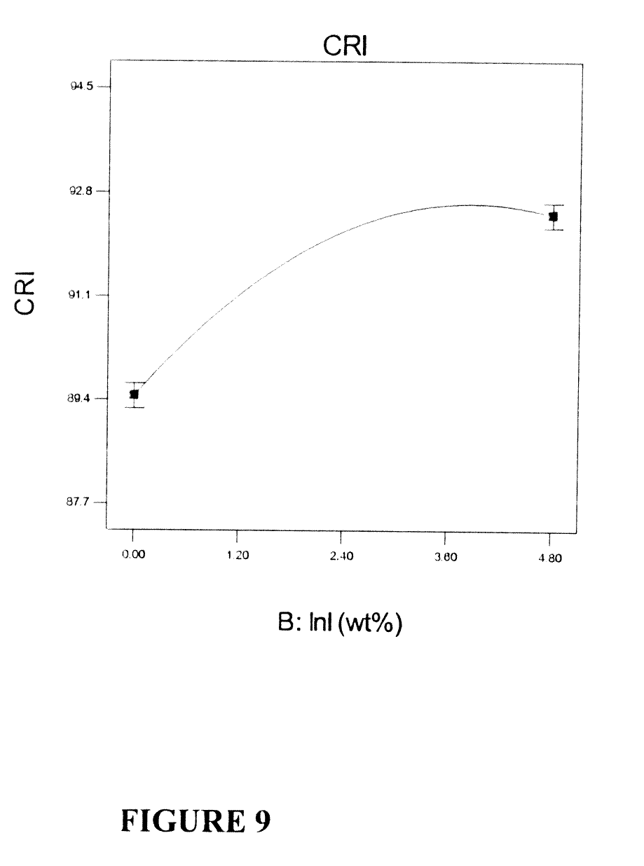

FIGS. 8 and 9 provide additional plots, this time focusing on the CRI of a lamp having the dose amounts indicated above in Table 2 and Table 3, for lamps having 20 W and 70 W designs, respectively. In both figures, gradual increase of CRI as a function of InI amount can be observed. A CRI of 80 or above is generally considered to be acceptable, for example for a 20 W lamp design. An even further increased goal might be a CRI as high as or higher than 90. With this as the goal, the one factor plot in FIG. 9 indicates that in the experimental case of 70 W at approximately 1.2 wt % added InI the CRI will reach the desired value of 90. It is also observed, that the CRI dependence on the added amount of InI decreases at higher InI levels. In the case of the 20 W experimental lamp, the goal of 80 CRI can be achieved at approximately 0.2 wt %, depending on the level of the TlI. It is also shown that as the amount of TlI in the dose is increased, the increase in CRI as a function of InI is less steep. However, in the case of the 70 W experimental lamp with higher InI level, FIG. 5 shows a constantly decreasing lumen output.

Therefore, based on the data and findings disclosed herein, it will be appreciated that testing of multiple response parameters should be carried out in order to determine the level of indium that may be added to a conventional lamp dose in order to optimize all of the desired parameters of the lamp, including for example lumen output, CCT, CRI, Dccy, and emission spectrum. By finding the best balance of dose elements and the respective amounts thereof, design parameters may be tailored to achieve the desired result. For example, using the foregoing data, it can be determined that, in that scenario using a lower level of approximately 0.2 wt % InI in a 20 W experimental lamp, only negligible decrease of lumen output was exhibited. Further, as shown in FIG. 8, the 20 W lamp required approximately 0.15 mol % InI to increase the CRI by one point. This data can be used to determine what level of InI may be added to a particular lamp design to achieve the optimum result.

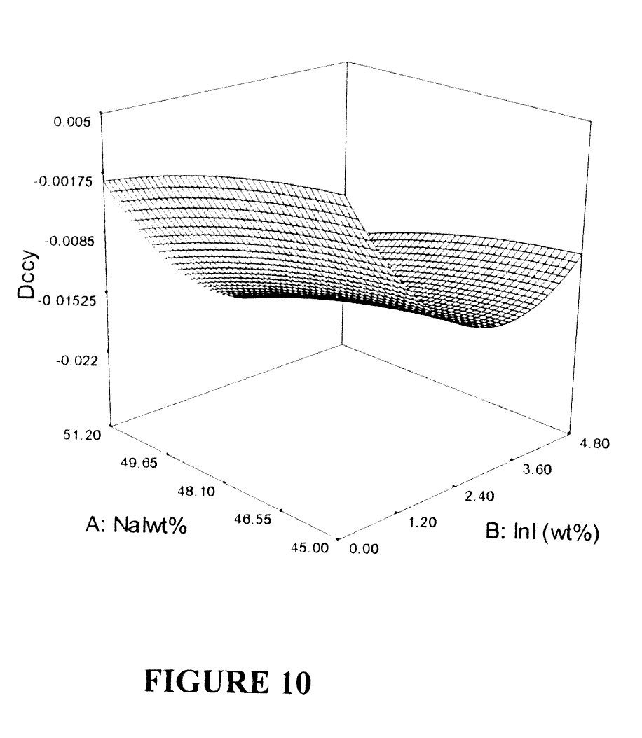

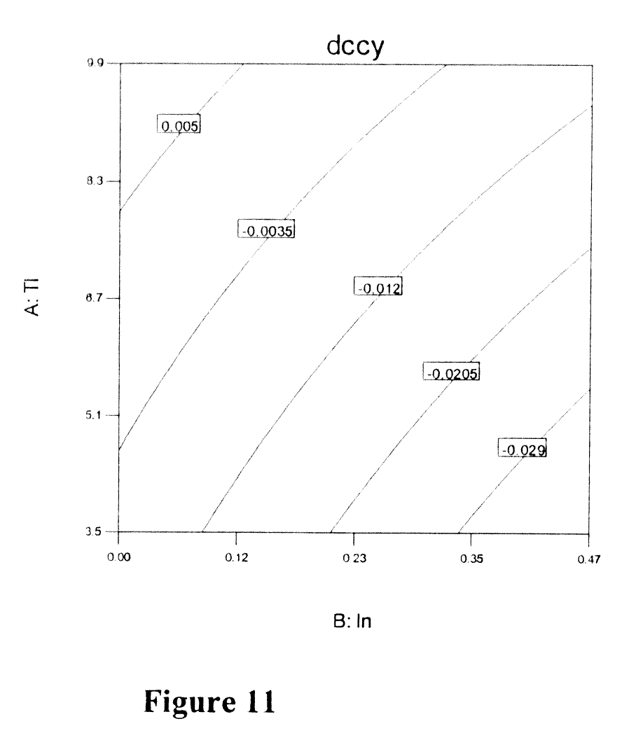

FIG. 11 provides still another surface plot, indicating the amount of NaI and InI that will in combination provide for emitted light having a Dccy in the aforementioned desirable range of 0.05 to −0.015. In FIG. 11, an added amount of 0.2 wt % to 4.8 wt % InI will ensure this range. NaI is shown to have less influence than InI. FIG. 10 provides a contour plot for the effect if InI and TlI. The amounts providing the aforementioned Dccy range are again easily determined using the plot provided.

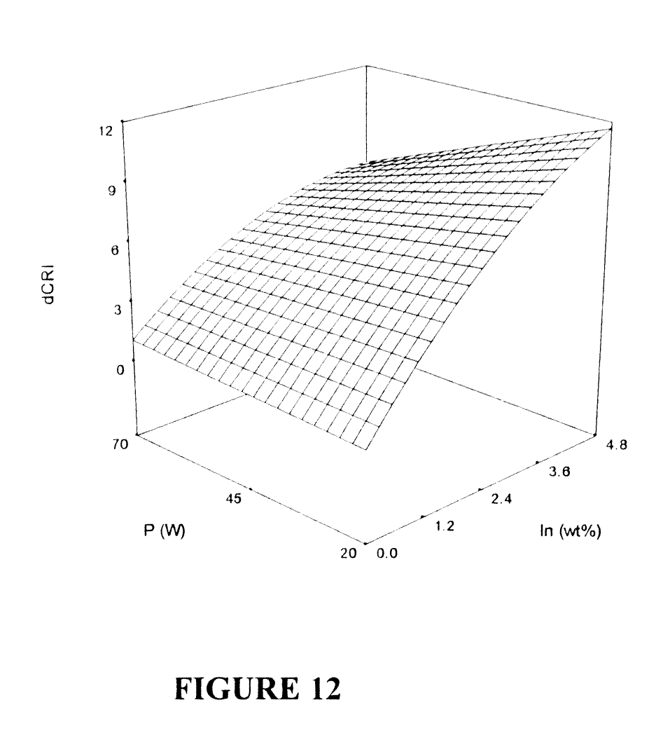

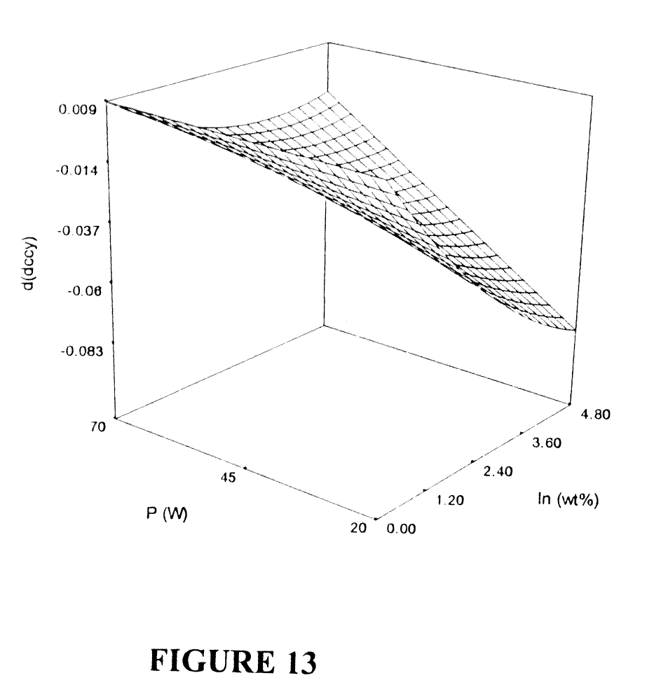

Based on the 20 W and 70 W design tests and results described above, one can use a combination of the different InI levels and wattage data provided to estimate the level needed for an intermediate power lamp, or even—by careful extrapolation—a lower or higher power lamp. As a further aide, two surface plots, FIG. 12 and FIG. 13, are provided. FIG. 12 provides a surface plot demonstrating change of the CRI from a reference point (a base cell in each test) as a function of the InI amount and power of the lamp. Because the levels of CRI at various wattages differ, only the change of the level can be shown in a joint graph. It is seen, however, that moving towards the lower power of the lamp, the effect of InI (i.e. the increase of CRI) is more pronounced. The same type of effect can be seen with regard to a decrease of dccy as exhibited in FIG. 13.

The ionizable fill 18 includes an inert gas, free mercury (Hg), indium iodide, and a further halide component. The further halide component includes a rare earth halide and may further include one or more of an alkali metal halide, an alkaline earth metal halide, and a thallium halide. In operation, the electrodes 20, 22 produce an arc between tips 28, 30 of the electrodes that ionizes the fill to produce a plasma in the discharge space. The emission characteristics of the light produced are dependent, primarily, upon the constituents of the fill material, the voltage across the electrodes, the temperature distribution of the chamber, the pressure in the chamber, and the geometry of the chamber. It is easy to see, therefore, why using only a very minor amount of InI in the fill is a desirable option, given that many of these parameters then remain substantially unaffected or only negligibly affected. In the following description of the fill, the amounts of the components refer to the amounts initially sealed in the discharge vessel, i.e., before operation of the lamp, unless otherwise noted.

The buffer gas may be an inert gas, such as argon, xenon, krypton, or a combination thereof, and may be present in the fill at from about 2-20 micromoles per cubic centimeter (μmol/cm³) of the interior chamber 14. The buffer gas may also function as a starting gas for generating light during the early stages of lamp operation. In one embodiment, suited to CMH lamps, the lamp is backfilled with Ar. In another embodiment, Xe or Ar with a small addition of Kr85 is used. The radioactive Kr85 provides ionization that assists in starting the lamp. The cold fill pressure may be about 60-300 Torr, although higher cold fill pressures are not excluded. In one embodiment, a cold fill pressure of at least about 120 Torr is used. In another embodiment, the cold fill pressure is up to about 240 Torr. Too high a pressure may compromise lamp start-up. Too low a pressure can lead to increased lumen depreciation over life of the lamp.

The mercury dose may be present at from about 2 to 35 mg/cm³ of the arc tube volume. The mercury weight is adjusted to provide the desired arc tube operating voltage for drawing power from the selected ballast.

The indium iodide component, InI, may be present in the fill at a total concentration of, for example, in a 70 watt lamp about 0.2 μmol/cm³. Similarly, in a 20 watt lamp the indium iodide component of the halide fill may be present in a concentration of about 0.8-1.2 μmol/cm³. It is the presence of indium iodide, at this very low level, that provides for the improved color properties of the lamp. Because the amount of indium iodide is so small, for example only about 0.2 μmol/cm³ in a 70 W lamp or even 0.8-1.2 μmol/cm³ in the case of 20 W lamp, the remaining fill components, known for use in standard and conventional lamps of the kind set forth herein, need not be substantially reduced. As such, those performance parameters provided by the remaining fill components are not sacrified, even though improved color properties are achieved.

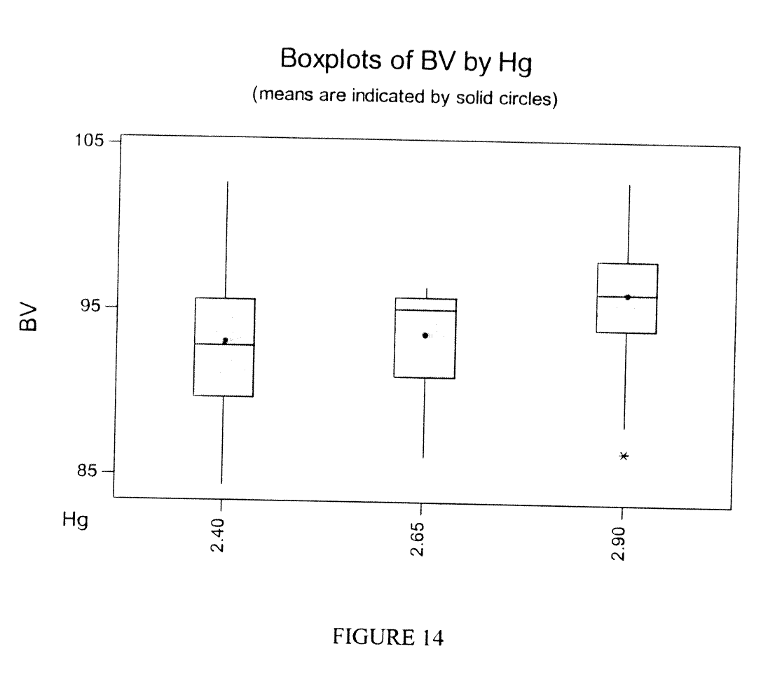

In addition, it has been found that the operating voltage of the lamp increases when even a very low amount of InI is added to the dose. Hence, to reduce the increased operating voltage back to the standard level the mercury required for lamp start-up and operation may be reduced by from about 15% -20%, due to the presence of indium in the fill. This effect is shown in FIG. 14. In the test, lamps with similar chemical composition were used. The one major difference between the lamps were that the first (control) group contained no InI, a second group contained an average of 1.7 wt % InI, and a third group contained an 2.9 wt % of InI. To demonstrate the effect of the InI on the operating voltage, different amounts of Hg were added to the different test lamp groups (2.9 mg, 2.65 mg and 2.4 mg, respectively). The tests were carried out in a 20 W lamp type. FIG. 14 shows the boxplot of the test results at the stated operating voltages. Although there is a statistically significant difference between the average operating voltages, the difference is only 3 volts (94V to 96V). Therefore, it can be concluded that the three groups had approximately the same operating voltages. To order to achieve substantially consistent operating voltages, approximately 9% less Hg was required for a lamp dose including 1.7 wt % InI, and 17% less Hg was required for a lamp dose including 2.9 wt % InI. An added benefit of the foregoing reduction in the amount of Hg dosed to the lamp is seen with regard to environmental and health concerns connected with the use of mercury, which are well documented.

The halide component may be present at from about 50 to about 700 μmol/cm³ of arc tube volume, e.g., about 100-600 μmol/cm³. A ratio of halide dose to mercury can be, for example, from about 1:1 to about 10:1, expressed by weight. In addition to the indium iodide, the remaining halide(s) in the halide component can each be selected from chlorides, bromides, iodides and combinations thereof. In one embodiment, the halides are all iodides. Iodides tend to provide longer lamp life, as corrosion of the arc tube and/or electrodes is lower with iodide components in the fill than with otherwise similar chloride or bromide components. The halide compounds usually will represent stoichiometric relationships.

The rare earth halide of the halide component may include halides of lanthanum (La), praseodymium (Pr), neodymium (Nd), cerium (Ce), samarium (Sm), and combinations thereof, and may further include any one or more of terbium, dysprosium, holmium, thulium, erbium, ytterbium, lutetium, and yttrium. The rare earth halide(s) of the fill can have the general form REX₃, where RE is selected from La, Pr, Nd, Sm, and Ce, and X is selected from Cl, Br, and I, and combinations thereof, and may be present in the fill at a total concentration of, for example, from about 0.3 to about 13 μmol/cm³. An exemplary rare earth halide from this group is lanthanum halide, which may be present at a molar concentration of at least 2% of the halides in the fill. In one embodiment, only rare earth halides from the group La, Pr, Nd, Sm, and Ce , indium iodide, sodium iodide, calcium iodide and thallium iodide are present in the fill. In another embodiment, the lamp fill includes any of the rare earth halides listed above, with indium iodide, sodium iodide, calcium iodide and thallium iodide.

The alkali metal halide, where present, may be selected from sodium (Na), potassium (K), and cesium (Cs) halides, and combinations thereof. In one specific embodiment, the alkali metal halide includes sodium halide. The alkali metal halide(s) of the fill can have the general form AX, where A is selected from Na, K, and Cs, and X is as defined above, and combinations thereof, and may be present in the fill at a total concentration of, for example, from about 10 to about 300 μmol/cm³.

The alkaline earth metal halide, where present, may be selected from calcium (Ca), and strontium (Sr) halides, and combinations thereof. The alkaline earth metal halide(s) of the fill can have the general form MX₂, where M is selected from Ca and Sr, and X is as defined above, and combinations thereof. In one specific embodiment, the alkaline earth metal halide includes calcium halide. The alkaline earth metal halide may be present in the fill at a total concentration of, for example, from about 3 to about 100 μmol/cm³.

The Group IIIa halide in addition to indium iodide, where present, may be thallium (Tl). The Group IIIa halide(s) of the fill may have the general form TIX or InX, where X is as defined above, and may be present in the fill at a total concentration of, for example, from about 0.15 to 15.0 μmol/cm³.

In one embodiment, the lamp is a 70 watt lamp and has a fill comprising an inert gas, indium iodide as about 0.2 mol % of the halide composition of the fill, and a further halide component including halides of sodium, thallium, calcium and lanthanum. In another embodiment, the lamp is a 20 watt lamp and has a fill comprising an inert gas, indium iodide as also about 0.2 mol % of the halide composition of the fill, and a further halide component including halides of sodium, thallium, calcium and lanthanum. In light of the foregoing, it is understood that the inclusion of indium iodide will prove beneficial for any other type of lamp having a halide dose, and as such is not limited to use in only 70 or 20 watt lamps.

Throughout of the previous paragraphs the indium iodide was added in the form of InI. Those skilled in the arts will realize that similar results can be expected when one doses the lamp with other chemical form of indium iodide.

All of the foregoing ranges, for not only dose composition but also color parameters, may be simultaneously satisfied in the present lamp design. Unexpectedly, this can be achieved with only negligible impact on lamp reliability or lumen maintenance. Thus, for example, the exemplary lamp may exhibit a CCT, CRI and color point correlating to improved color quality, i.e., white light emission, and yet maintain lumen output and lamp life in accord with known, desirable standards.

The invention has been described with reference to the preferred embodiments. Obviously, modifications and alterations will occur to others upon reading and understanding the preceding detailed description. It is intended that the invention be construed as including all such modifications and alterations.

Having thus described the invention, it is now claimed:

1. A lamp comprising:
a discharge vessel;
electrodes extending into the discharge vessel; and
an ionizable fill sealed within the vessel, wherein the fill includes:
an inert gas,
a source of mercury;
indium iodide, and
a further halide component including:
a sodium halide,
a thallium halide,
at least one of a calcium halide and a strontium halide, and
at least one of a rare earth halide selected from the group consisting of lanthanum, cerium, praseodymium, neodymium, and samarium, and combinations thereof.

2. The lamp of claim 1, wherein the lamp the fill contains indium iodide in the range of from about 0.15 wt % to about 4.0 wt %.

3. The lamp of claim 1, wherein the lamp is a 70 watt lamp and the fill contains about 0.2 mol % of indium iodide.'

4. The lamp of claim 1, wherein the lamp is a 20 watt lamp and the fill contains about 0.2 mol % of indium iodide.

5. The lamp of claim 2, wherein the lamp exhibits an increased emittance between 440 nm and 470 nm of about 10% up to 115%, over an indium-free system.

6. The lamp of claim 3, wherein the lamp exhibits lumen output and lamp life equal to that of a lamp having the same fill components but without indium iodide.

7. The lamp of claim 4, wherein the lamp exhibits lumen output and lamp life equal to that of a lamp having the same fill components but without indium iodide.

8. The lamp of claim 1, wherein the amount of mercury included is up to 15-20% less than the amount included in an identical but indium-free lamp exhibiting identical operating parameters.

9. The lamp of claim 1, wherein the further halide comprises sodium halide, thallium halide, calcium halide and lanthanum halide.

10. The lamp of claim 1, wherein the fill may further include halides of holmium, thulium, dysprosium, erbium, lutetium, yttrium, ytterbium, terbium, scandium, and magnesium.

11. The lamp of claim 1, wherein the further halide component is selected from the group consisting of chlorides, bromides, iodides and combinations thereof.

12. The lamp of claim 1, wherein the further halide component is an iodide.

13. A method of forming a lamp, comprising:
providing a discharge vessel;
sealing an ionizing fill within the vessel, the fill including;
an inert gas,
a source of mercury;
indium iodide,
a further halide component including:
a sodium halide,
a thallium halide,
at least one of a calcium halide and a strontium halide, and
at least one of a rare earth halide selected from the group consisting of lanthanum, cerium, praseodymium, and neodymium; and
positioning electrodes within the discharge vessel to energize the fill in response to a voltage applied thereto.

14. The method of claim 13, wherein the fill comprises NaI, TlI, CaI, LaI, and about 0.15 wt % to about 4.0 wt % InI, and exhibits a CRI of at least 80.

15. The method of claim 14, wherein the lamp exhibits an increase in emittance of from about 10% to about 115% in the spectral range of about 440 nm to about 470 nm.

16. The method of claim 13, wherein the amount of mercury sealed within the vessel as part of the ionizing fill is up to 15-20% less than the amount included in an identical but indium-free lamp exhibiting identical operating parameters.

17. The method of claim 13, wherein the lamp is a 70 watt lamp and the fill contains about 0.2 mol % of indium iodide.

18. The method of claim 13, wherein the lamp is a 70 watt lamp and the fill contains about 0.2 mol % of indium iodide.

19. The lamp of claim 17, wherein the lamp exhibits lumen output and lamp life equal to that of a lamp having the same fill components but without indium iodide.

20. The lamp of claim 18, wherein the lamp exhibits lumen output and lamp life equal to that of a lamp having the same fill components but without indium iodide.
